(19) United States
(12) Patent Application Publication
(10) Pub. No.: US 2011/0008715 A1
(43) Pub. Date: Jan. 13, 2011

(54) PLATINUM LOADED SUBSTRATE FOR A FUEL CELL AND METHOD FOR PRODUCING SAME

(76) Inventors: Belabbes Merzougui, East Windsor, CT (US); Shampa Kandoi, Rocky Hill, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/920,173

(22) PCT Filed: Mar. 28, 2008
(86) PCT No.: PCT/US08/58567

§ 371 Date: Aug. 30, 2010

(51) Int. Cl. H01M 4/92; H01M 4/88

(52) U.S. Cl. 429/524; 502/101

(57) ABSTRACT

A method of depositing platinum onto a support is disclosed. This method is based on a combination of two processes: electrochemical and electroless deposition, using a chemical bath containing a platinum source and agents that trigger nucleation and buffer the solution. This method is capable of producing a catalyst having a gravimetric current density of at least approximately 0.8 mA/cm2 per ?g of platinum per cm2 at cell voltage of 0.9V/RHE for oxygen reduction reaction.

### TECHNICAL FIELD

This disclosure relates to the deposition of a platinum catalyst onto a support material and the resulting structure. More particularly, the invention relates to the deposition of a platinum catalyst onto a carbon support and a method for producing such a catalyzed structure that is highly active and stable as a fuel cell catalyst with a relatively low platinum content.

### BACKGROUND

Cost and durability issues have made it difficult to commercialize fuel cells. Fuel cells utilize a catalyst that creates a chemical reaction between a fuel, such as hydrogen, and a reactant, such as oxygen, typically from air. The catalyst is typically platinum loaded onto a support, which is usually a high surface area carbon.

Some durability issues are attributable to the degradation of the support caused by corrosion. Electrochemical studies have indicated that the corrosion rate is proportional to the surface area of carbon. For example, it has been reported that carbon with high surface area, such as ketjen black, corrodes severely at potentials above 1 V/RHE. Accordingly, to overcome this particular durability issue, it is desirable to use a carbon support with a relatively low surface area that is more chemically and electrochemically stable, such as carbon fiber or graphite powder.

The conventional deposition method used for depositing platinum on graphite presents several difficulties. First, this method results in large platinum particles with low active surface area, which is not beneficial to fuel cell from a performance and cost perspective. Low surface area platinum particles result in a large amount of platinum being used to obtain the desired fuel cell performance. Since platinum is very costly, increased loadings drive up the cost of the fuel cells, which reduces it commercial viability. Second, the oxygen reduction activity of this catalyst manufactured with the conventional deposition method is insufficient to achieve the required fuel cell performance due to the relatively low surface area of platinum.

What is needed is a deposition method enabling the use of a low surface area support, such as graphite, to improve durability relative to corrosion. What is also needed is a method that results in a catalyzed support having a low platinum loading with high oxygen reduction activity.

### SUMMARY

A method of depositing platinum onto a support is disclosed. This deposition method is based on a combination of two processes: electrochemical and electroless deposition. The process requires using a chemical bath containing a platinum source and agents that trigger nucleation and buffer the solution. This method is capable of producing a catalyst having a gravimetric current density of at least approximately 0.8 mA/cm² per μg of platinum per cm² at cell voltage of 0.9V/RHE for oxygen reduction reaction.

These and other features of the disclosure can be best understood from the following specification and drawings, the following of which is a brief description.

### BRIEF DESCRIPTION OF THE DRAWINGS

FIG. 1 is a graph showing the first five cycles of initial activation of an example catalyst prepared in accordance with the disclosed method.

FIG. 2 is a graph illustrating the cyclic voltammetry behavior of example catalyst relative to prior art catalyst having much higher platinum loading.

FIG. 3 is a graph illustrating oxygen reduction reaction activity of the example catalyst relative to prior art catalyst of various platinum loadings.

FIG. 4 is a graph illustrating the kinetics current of the example catalyst relative to prior art catalysts of various platinum loadings.

### DETAILED DESCRIPTION

An example method of depositing platinum on a carbon support is disclosed. The method can also be applied to metallic supports or other non-metallic supports. In one example, the carbon support is carbon fiber or graphite. The deposition method includes both an electrochemical and electroless deposition (ECED) onto a carbon support. This deposition method produces more highly dispersed, porous platinum deposits than prior art methods; which results in a highly active catalyst with low platinum content.

The carbon support is submersed in a solution containing a noble metal source.

In one example, the noble metal source is a platinum source. The platinum source in one example is diamino dinitro platinum. Other noble metals include Pd, Au, Ru, Rh, Ir, Os or alloys thereof. A secondary metal source may also be used to reduce the amount of platinum or other noble metal needed to achieve the desired activity. One example of secondary metal source is a transition metal, such as cobalt. The cobalt source results in the production of Co, CoP and PtCo. Other transition metal could be Ni, Fe, Cu, Mn, V, Ti Zr, or Cr. A third metal source containing gold, nickel and/or copper can also be used.

A suitable chemical agent is added to the solution to achieve nucleation of the platinum for electroless deposition. One example agent is sodium hypophosphate. Other agents similar to sodium hypophosphate can be used. Other agents such as alcohols, sugars, H₂O₂ are alternative chemical agents. In one example, the temperature of the solution is within 0-90° C.

Other chemicals are also added to the solution to buffer the support interfacial layer. One example desired pH range is 3.0-8.0. Water or an organic solvent may be used as the working medium. The solution can therefore be aqueous or non-aqueous.

The solution is exposed to an inert atmosphere, such as nitrogen or argon, for example by bubbling, to avoid air-hydrogen reaction on platinum. It is believed that the evolving hydrogen helps in the formation of porous platinum on the surface of the support.

Example Manufacturing Method of Platinum-Loaded Support:

A three-electrode jacket cell with 100 mL volume was used for catalyst deposition using the example ECED method. Glassy carbon (5 mm diameter) and carbon paper (Toray) were chosen as supports for catalyst deposition in nitrogen atmosphere at temperature, 60° C. and pH 5. The following chemicals were used without further purification. They are: NaH₂PO₂ (1.0 mM), (NH₃)₂(NO₂)₂Pt (0.3 mM), Co (ClO₄) 2.6H₂O (1.24 mM), (NH₄)₂SO₄ (5.4 mM), and BH₃O₃ (2.7 mM).

Platinum gauze and saturated calomel electrodes were used as counter and reference electrodes, respectively. The applied current density for all electrodes was 10 mA/cm². However, the deposition time was chosen depending on the desired catalyst loadings on the substrate. For example, to obtain a geometric Pt loading of 12.5 μg/cm², the deposition time was 100 seconds.

Activation of the Fuel Cell Catalyst:

For fuel cell catalyst activity and durability, the glassy carbon substrate was polished on 0.05 μm alumina and ultrasonically treated and rinsed with iso-propanol alcohol before deposition. Electrochemical evaluation of the catalyst was performed in 0.1 M HClO₄ at 25° C.

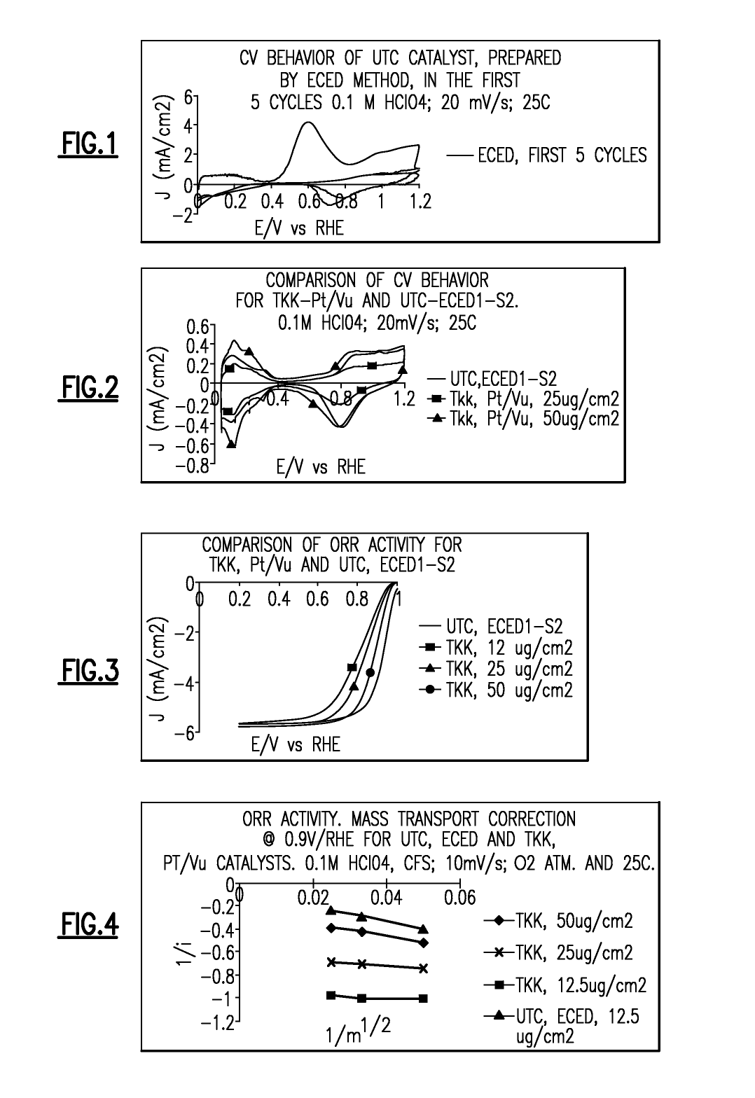

It was found that the ECED method generated catalysts that require an initial activation prior to evaluation. As shown in FIG. 1, in the first cycle, a large anodic peak appeared at potential 0.6 V/RHE. This anodic process may be due to oxidation of an alloy, such as cobalt phosphorus (CoP) and Platinum cobalt phosphorus (PtCoP). After one cycle, the catalyst shows a behavior close to that of Pt. The open circuit voltage of the electrode increased from 0.3 V/RHE to 1 V/RHE during the first five cycles indicating a full activation.

As shown in FIG. 2, the hydrogen adsorption and desorption peaks are more pronounced and shifted toward more positive potential. Such properties may be related to formation of Pt-metal-phosphorus alloys as reported elsewhere by R. Marassi (Electrochimica Acta, 52, 5574-5581, 2007).

Oxygen Reduction Activity of the Fuel Cell Catalyst:

The above example electrodes were tested for oxygen reduction reaction (ORR) activity. FIG. 3 shows the electrode responses at 1600 rpm and 10 mV/s. It is clear that the example fuel cell catalyst has the highest half-wave potential for ORR. In comparison with TKK Pt/Vu, and within the same Pt loading ranges, the example fuel cell catalyst shows an increase in ORR activity of 100 mV. This shift could be due to (1) ECED method that generates highly porous catalysts as a result of hydrogen evolution and non-noble metal dissolution, and/or (2) cobalt phosphorus alloy formation that causes some changes in the electronic environment of Pt structure leading to formation of a highly active surface.

To determine kinetics current for the example fuel cell catalyst in comparison with other fuel cell catalysts, the Levich equation was used:

1/i (0.9V/RHE)=1/iₖ+1/i_{d}=1/iₖ+1/βω^{1/2}

As illustrated in FIG. 4, the example fuel cell catalyst kinetics current generated by the disclosed ECED method is estimated to be 20 mA/cm² higher than that reported for Pt₃Ni(111) (Markovic, 2006 DOE Review). In the following table, the specific activity (SA) and mass activity (MA) for ORR are presented in comparison with a conventional catalyst, Pt/Vu. It is clear that the catalyst prepared with ECED method provides a mass activity, which is 9 times higher than that of TKK, Pt/Vu. This behavior is unique and may be due to several factors such as, surface area, chemical composition, electronic structure, and surface morphology.

| TKK, Pt/Vulcan, 47% Pt | | | | ECED |
|---|---|---|---|---|
| | 12 μg/cm² | 25 μg/cm² | 50 μg/cm² | 12.5 μg/cm² |
| E ½ (mV) @ | 810 | 842 | 888 | 932 |
| 1600 rpm | | | | |
| SA (μA/cm² Pt) | 210 | 150 | 186 | 870 |
| MA (A/mg Pt) | 0.083 | 0.062 | 0.076 | 0.92 |
| HAD* (m²/g Pt) | 39.5 | 40.9 | 41.2 | 105 |

*HAD: hydrogen adsorption-desorption

Although an example embodiment has been disclosed, a worker of ordinary skill in this art would recognize that certain modifications would come within the scope of the claims. For that reason, the following claims should be studied to determine their true scope and content.

What is claimed is:

1. A method of depositing noble metal onto a support comprising the steps of:
submersing a low surface area support in a solution containing a noble metal source and a specific catalyzed solution that triggers nucleation and buffers the solution;
electrochemically depositing noble metal onto the said support using an electrical current; and
electrolessly depositing noble metal onto the said support, separate from the electrochemical deposition, using the catalyzed solution.

2. The method according to claim 1, wherein the said support is a low surface area metallic or non metallic material.

3. The method according to claim 1, wherein the catalyzed solution contains sodium hypophosphate.

4. The method according to claim 1, comprising the step of producing a noble metal-loaded carbon supported fuel cell catalyst subsequent to the noble metal deposition steps having an oxygen reduction activity of at least approximately 0.8 mA/cm² per μg of platinum per cm².

5. The method according to claim 1, comprising the step of bubbling an inert gas into the solution.

6. The method according to claim 1, wherein the solution can be aqueous or non-aqueous.

7. The method according to claim 1, comprising the step of adjusting the pH of the solution to a range of approximately 3.0-8.0.

8. The method according to claim 1, wherein the temperature of the solution is in the range of 0 to 90° C.

9. The method according to claim 1, wherein the noble metal is one of Pt, Pd, Au, Ru, Rh, Ir, Os, or a mixture thereof.

10. The method according to claim 9, comprising the step of providing a secondary metal source that includes a transition metal.

11. The method according to claim 10, wherein the transition metal is at least one of Co, Ni, Fe, Cu, Mn, V, Ti Zr, or Cr.

12. A method of electrolessly depositing platinum onto a support comprising the steps of:
submersing a support in a solution containing sodium hypophosphate and a platinum source; and
electrolessly depositing platinum onto the support.

13. The method according to claim 9, comprising the step of bubbling an inert gas into the solution.

14. A platinum-loaded carbon supported fuel cell catalyst comprising:
a carbon support containing platinum and having a gravimetric current density of at least approximately 0.8 mA/cm² per μg of platinum per cm² at cell voltage of 0.9V/RHE.

15. The fuel cell catalyst according to claim 9, wherein the substrate is graphite.
